(19) United States
(12) Patent Application Publication
(10) Pub. No.: US 2005/0198250 A1
(43) Pub. Date: Sep. 8, 2005

(54) Network system, method and protocols for hierarchical service and content distribution via directory enabled network

(75) Inventor: Yunsen Wang, Saratoga, CA (US)

Correspondence Address: BACON & THOMAS, PLLC, 625 SLATERS LANE, FOURTH FLOOR, ALEXANDRIA, VA, 22314, US

(73) Assignee: Terited International, Inc.

(21) Appl. No.: 11/075,060

(22) Filed: Mar. 8, 2005

Related U.S. Application Data
(63) Continuation of application No. 09/827,163, filed on Apr. 6, 2001.

(51) Int. Cl. G06F 15/173

(52) U.S. Cl. 709/223

(57) ABSTRACT

A network system manages hierarchical service and content distribution via a directory enabled network to improve performance of the content delivery network with a hierarchical service network infrastructure design. The network system allows a user to obtain various Internet services, especially the content delivery service, in a scalable and fault tolerant way. In particular the network system is divided into 4 layers, each layer being represented and managed by a service manager with back up mirrored managers. The layer 4 service manager is responsible for management of multiple content delivery networks (CDNs). The layer 3 service manager is responsible for management of one CDN network that has multiple data centers. The layer 2 service manager is responsible for management of one data center that has multiple server farms or service engine farms. The layer 1 service manager is responsible for all servers in a server farm. Each server of the server farm can be connected by a LAN Ethernet Switch Network that supports the layer 2 multicast operations or by an Infiniband switch.

This application is a Continuation of nonprovisional application Ser. No. 09/827,163 filed Apr. 6, 2001.

### FIELD OF THE INVENTION

The present invention relates to a method and systems for exchanging service routing information, and more particularly, to a method and systems for management of hierarchical service and content distribution via a directory enabled network by protocols that dramatically improve the performance of a content delivery network via a hierarchical service network infrastructure design.

### BACKGROUND OF THE INVENTION

The Web has emerged as one of the most powerful and critical media for B2B (Business-to Business), B2C (Business-to Consumer) and C2C (Consumer-to Consumer) communication. Internet architecture was based on centralized servers delivering content or service to all points on the Internet. The Web traffic explosion has thus caused lots of Web server congestion and Internet traffic jams. Accordingly, a content delivery network is designed as a network that requires a number of co-operating, content-aware network devices that work with one another, in order to distribute content closer to users and locate the content at a location that is nearest to a subscriber upon request.

An Internet routing protocol such as BGP is designed to exchange large Internet routes among routers. BGP is an exterior routing protocol is connection-oriented and runs on top of TCP, will maintain the neighbor connection through keep-alive messages, and synchronizes the consistent routing information throughout the life of connection. However, BGP will not exchange information in this web server centric Internet. Therefore, it would be helpful to have a service (in LDAP directory format) routing protocol to exchange service information in a hierarchical way for service and content distribution management via a directory enabled network so as to improve the performance of the content delivery network and service provision and management.

### SUMMARY OF THE INVENTION

It is an object of the present invention to provide a network system having multiple levels for improving performance of the content delivery network via a hierarchical service network infrastructure design.

A further object of the present invention is to provide a method and protocols that delivers quality content through hop by hop flow advertisement from server to client with crank back when a next hop is not available. In accordance with the foregoing and other objectives, the present invention proposes a novel network system and the method thereof for management of hierarchical service and content distribution via a directory enabled network.

The network system of the present invention includes a server that exchanges service information with the level 1 service manager, for example by protocols which are the subject of a copending patent application.

In order to manage such a scalable network, some concepts from Internet routing are utilized. The Internet routing protocol such as BGP is designed to exchange large Internet routes with its neighbors. The protocol will exchange the information among service managers in a hierarchical tree structure so as to help provide a better and scalable service provisioning and management. The information exchanged by this protocol is defined as the very generic directory information schema format that is formed as part of the popular industry standard of LDAP (light weight directory access protocol). The protocol is referred to as DGP (Dissimilar Gateway Protocol), which is a directory information routing protocol. Dissimilar Gateway Protocol is similar to an exterior routing protocol BGP, except that the directory information is exchanged between DGP parent and child service manager. The BGP, on the other hand, exchanges IP route information with its neighbors. Similar to BGP, the Dissimilar Gateway Protocol is connection oriented and running on top of TCP and will maintain the neighbor connection through keep-alive messages and synchronize the consistent directory information throughout the life of connection. In the load balance among multiple data centers, the method of proximity calculation and the data center's loading factor is proposed to be used by DNS to select the best data center as the DNS responses to the subscriber. In the LAN environment, in order to simultaneously update the information to the service devices and to improve performance, a reliable Multicast Transport Protocol is provided to satisfy this purpose. Running on top of this reliable Multicast Transport Protocol, a Reliable Multicast Directory Update Protocol is also invented to improve performance by multicasting of directory information in a manner similar to that of the standard LDAP operations. In order to manage this service network more efficiently, the Reliable Multicast Management Protocol is also provided to deliver management information to the service devices simultaneously to improve performance and reduce management operation cost. In order to push the content closer to the subscriber, the use of a cache is helpful, but the cache content has to be maintained to be consistent with origin server. A cache invalidation method through DGP propagation is invented to help maintain the cache freshness for this content delivery network. In order to manage the network more efficiently, a method of dynamic discovery of Service Engines, including a Level 1 service manager and Level 2 service manager, is provided through the LAN multicast and link state routing protocol's opaque link state packet flooding with service information.

In order to support content delivery which meets quality requirements such as streaming media content, a method of delivering the content through hop by hop flow advertisement from service engine to client with crank back when a next hop is not available) is provided to work with or without other standard LAN or IP traffic engineering related protocols.

### BRIEF DESCRIPTION OF THE DRAWING

The above and other objects and advantages of the invention will be apparent upon consideration of the following detailed description, taken in conjunction with the accompanying drawings, in which the reference characters refer to like parts throughout and in which:

FIG. 1 is a diagram illustrating Content Peering for Multiple CDN Networks in accordance with the system of the present invention;

FIG. 2a is a diagram illustrating an Integrated Service Network of Multiple Data Centers in accordance with the system of the present invention;

FIG. 2b is a diagram illustrating another Integrated Service Network of Multiple Data Centers in accordance with the system of the present invention;

FIG. 3 is a diagram illustrating Service Manager and Caching Proxy Server Farm in a Data Center in accordance with the system of the present invention;

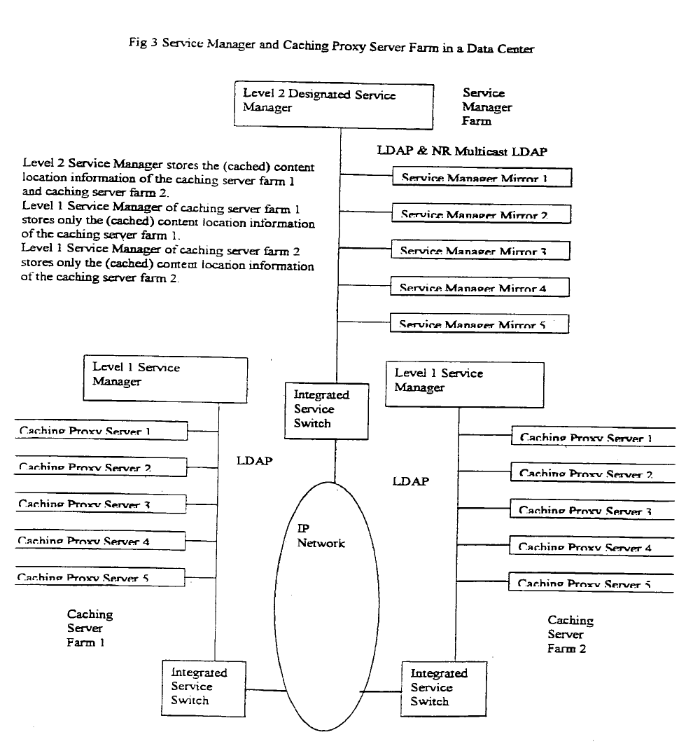

FIG. 4 is a diagram illustrating Directory Information Multicast Update in Service Manager Farm in accordance with the system of the present invention;

FIG. 5(a) is a diagram illustrating an Integrated Service LAN in accordance with the system of the present inventions;

FIG. 5(b) is a sequence diagram illustrating Reliable Multicast Transport Protocol Sequence in accordance with the method and system of the present invention;

FIG. 6 is a sequence diagram illustrating Transport Multicast abort operation sequence in accordance with the method and system of the present invention;

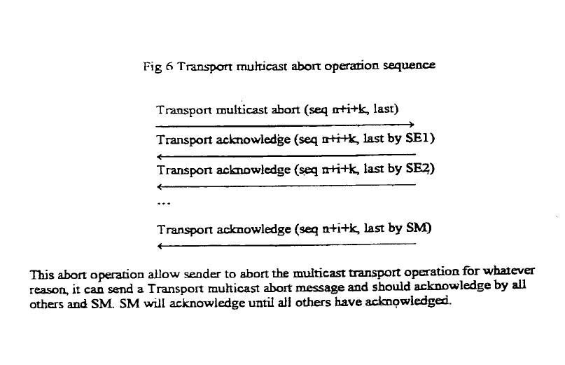

FIG. 7 is a sequence diagram illustrating Reliable Multicast Directory Update Protocol Sequence in accordance with the method and system of the present invention; and

FIG. 8 is a sequence diagram illustrating Reliable Multicast Management Protocol Sequence in accordance with the method and system of the present invention.

### DETAILED DESCRIPTION OF THE PREFERRED EMBODIMENTS

Layers of the Network System

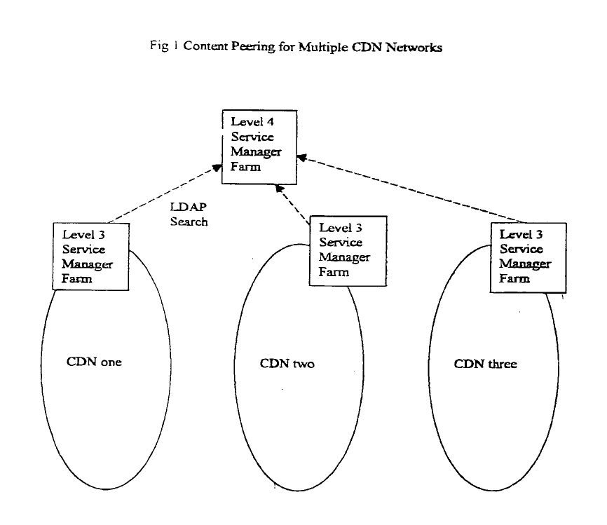

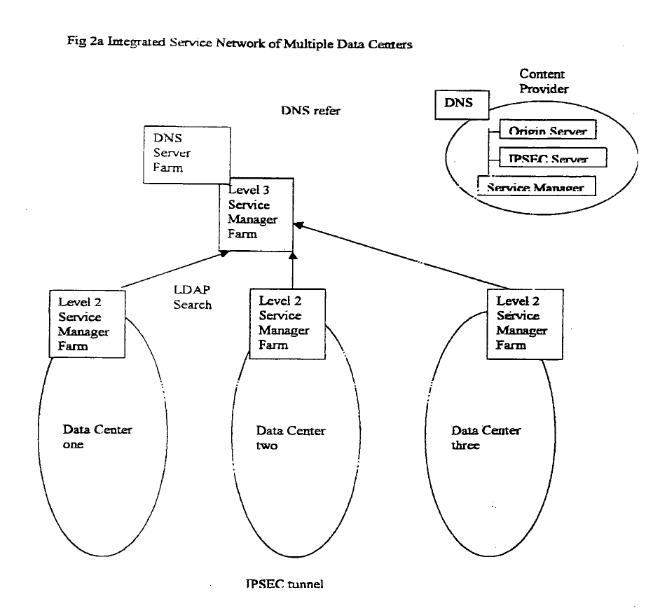

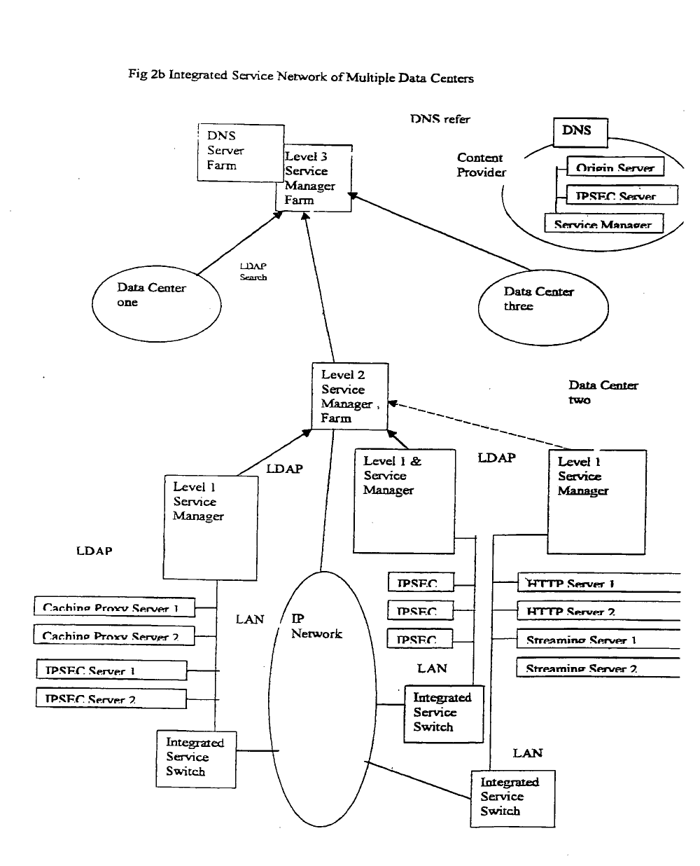

In the embodiment shown in FIG. 1, a level 4 service manager stores content location information for content delivery networks CDN one, CDN two, and CDN three. On the other hand, a level 3 service manager of a CDN one stores only the content location information of CDN one, a level 3 service manager of CDN two stores only the content location information of CDN two, and a level 3 service manager of CDN three stores only the content location information of CDN three. Referring to FIG. 2, the level 3 service manager stores the content location information of data centers one, two and three, while the level 2 service managers respectively store content location information for individual data centers one, two, and three, which can in turn include a variety of servers and/or networks, the content location information for which is stored in level 1 service managers as illustrated in FIG. 2b. This hierarchical directory enabled network provides secure content distribution and also other services, and may be referred to an a hierarchical scalable integrated service network (HSSISN).

Services by this Network

The hierarchical network illustrated in FIGS. 1, 2a, and 2b can provide Web and Streaming Content distribution service, Web and Streaming content hosting service, IPSEC VPN service, Managed firewall service, and any other new IP services in the future.

Components of this Hierarchical Scalable Integrated Service Networks (HSISN)
The network may include any or all of the following components: Integrated Service Switch(es) (ISS);
IP switch(es) that forward IP traffic based on service and flow specification;
Service Engine(s) (Server(s));
Service System(s) (which may come with special hardware) that processes HTTP, cache, IPSEC, firewall or proxy etc.;
The above-mentioned Service Managers; and
A designated system running as management agent and also as LDAP server for an LDAP search service, and also running a Diverse Gateway Protocol with its parent service manager and child service manager to exchange directory information.

The LDAP Schema provides directory information definitions, which are exchanged by service manager and searched by LDAP client. In addition, an SNMP MIB is provided to provide definitions of the management information, which are used between SNMP network manager and agent.

Protocols

The network may also used any of the following protocols:

Standard Protocols

Existing routing protocols (OSPF, BGP) may be run on ISS to interoperate with other routers in this network. Each server runs LDAP as a client; and the service manager will also run as an LDAP server to service a service engine LDAP search request.

Other Protocols

The network may also run other protocols such as the Service Information Protocol, which is described in a copending application.

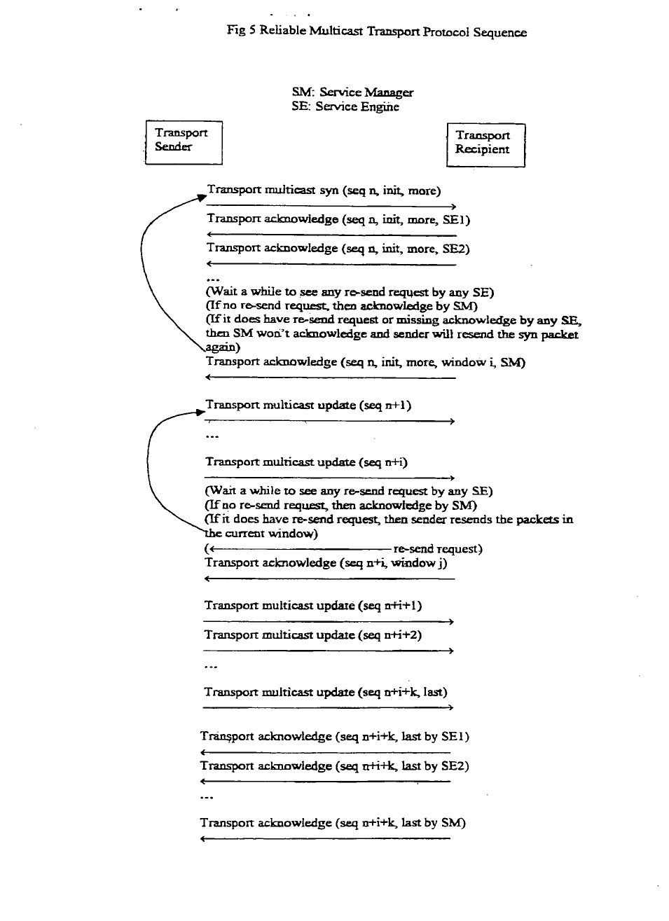

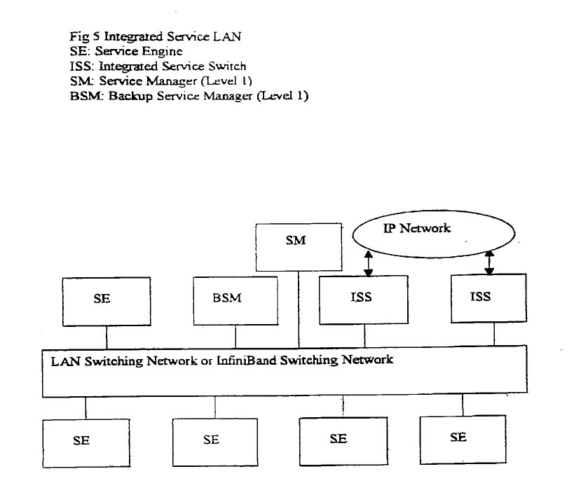

Referring to FIG. 5(a), the service information protocol is run in a LAN or InfiniBand (a new I/O specification for servers) environment between the ISS, service engines and level 1 Service manager to:
1. register/de-register/update service and service attributes; and
2. handle service control advertisement—service engine congestion, redirect etc.

Unlimited service engines can be supported (extremely high scalability with multiple boxes). Service control advertisements will dynamically load-balance among service engines because the ISS will forward messages based on these advertisements to an available (less congested) service engine. A keep-alive message between the ISS and service manager will help detect the faulty device, which ISS will be removed from its available service engine list.

Another protocol that may be used is the Flow Advertisement Protocol, as described in a copending application, which is initiated by a service engine to an ISS (application driven flow or session) by establishing a flow in an ISS to allow flow switching. The flow comes with flow attributes; one of the attributes is the QoS. Other flow attributes are also possible.

Flow attributes of QoS can enforce streaming content quality delivery requirements. The flow will map to outside network by ISS to existing or future standards such as MPLS, DiffServ, 802.1p, or Cable Modem SID.

The Assigned Numbers Authority Protocol is also described in a copending application, and controls any kind of number that needs to be globally assigned to a subnet, LAN, or InfiniBand by controlling IP address pool, MPLS label range, global interface number, HTTP cookies etc. A designated service manager is elected in each of the subnet (on behalf of a service engine farm including ISS). According to this protocol, the service type is represented in a packet pattern matching way, so that different kinds of service engines can be mixed in the same subnet or LAN and all different kinds of service engines can be represented by the same service manager.

Referring to FIG. 1, which illustrates Content Peering for Multiple CDN Networks, and FIG. 2a and FIG. 2b, which illustrate an Integrated Service Network of Multiple Data Centers, The Dissimilar Gateway Protocol (DGP) is defined as a directory information routing protocol, which utilizes similar concepts from exterior routing protocol BGP, except that the directory information is exchanged between the DGP parent and child instead of IP routes exchanged between BGP neighbors. Similar to BGP, the Dissimilar Gateway Protocol is connection-oriented and running on top of TCP and will maintain the neighbor connection through keep-alive message and synchronize the consistent directory information during the life of connection. However, the DGP connection is initiated from parent service manager to child service manager to avoid any connection conflict if both parent and child service manager try to initiate the DGP connection at the same time. To avoid any forwarding loop, the connection is not allowed between the same level service managers. It is only allowed between a parent service manager and a child service manager, although it is possible to have multiple back up parent service managers connected to the same child service manager to provide the child service manager with an LDAP search service for redundancy reasons.

The Level 1 service manager (on behalf of one service subnet) will establish a DGP connection with its parent service manager (Level 2 service manager). Usually the level 2 service manager will be running on behalf of the whole Data Center.

The Level 2 service manager will also establish a DGP connection with its parent service manager (Level 3 service manager). Usually the service manager of an original server farm will also establish a DGP connection with its parent service manager (Level 2 or Level 3 service manager).

The Level 3 service manager usually will also run as a DNS server, which will direct the user to request a different data center as a geographical load balancing. The DNS redirection decision can be based on the service loading attribute updated by the service data center through DGP incremental updates and other attributes such as proximity to subscriber.

The initial DGP connection will exchange the directory information based on each other's directory information forwarding policy. After the initial exchange, each service manager will only incrementally update (add or withdraw) its directory information service and service attributes, content and content attributes etc. to the other side. One of the service attributes is the loading factor (response time) of the service domain the service manager represents, and one of the content attributes is the content location including cached content location. The DGP packet types are OPEN, LDAP_ADD, LDAP_DELETE, LDAP_MODIFY_ADD, LDAP_MODIFY_REPLACE, LDAP_MODIFY_DELETE, NOTIFICATION and KEEPALIVE.

Content change is treated as the content attribute (content time) change for that content, and will be propagated to the caching server that has the cached content, as described in more detail below. For frequently changed content, like BGP, DGP supports directory information damping which will suppress the frequently changed directory information propagation. Similar to BGP, DGP also supports policy-based forwarding between its parent and children service managers. It is recommended to apply the aggregation policy to aggregate directory information before forwarding. Also similar to BGP, the TCP MD5 will be used for authentication.

As mentioned above, proximity calculation is used with service loading attributes updated by each data center to make a DNS server direct a user request to best service data center as a geographical load balancing. Each IP destination (IP route, address and mask) is assigned an (x, y) attribute. The x stands for longitude (between −180 to +180, but −180 and +180 is the same location because the earth is a globe) and y stands for latitude (between −90 to +90) on earth where the IP destination is physically located.

Assuming that the subscriber's source address matches the longest prefix of an IP destination with an (x1, y1) attribute and the Data Center's IP address prefix has the attribute of (x2, y2), then:
If |x1−x2|<=180, the distance between the subscriber and data center is (x1−x2)²+(y1−y2)²)^{1/2}
If |x1−x2|>180, then the distance between the subscriber and data center is 360−(|x1−x2|))²+(y1−y2)²)^{1/2}
The (x,y) route attribute can be proposed to IETF as the extension of the BGP route attribute.

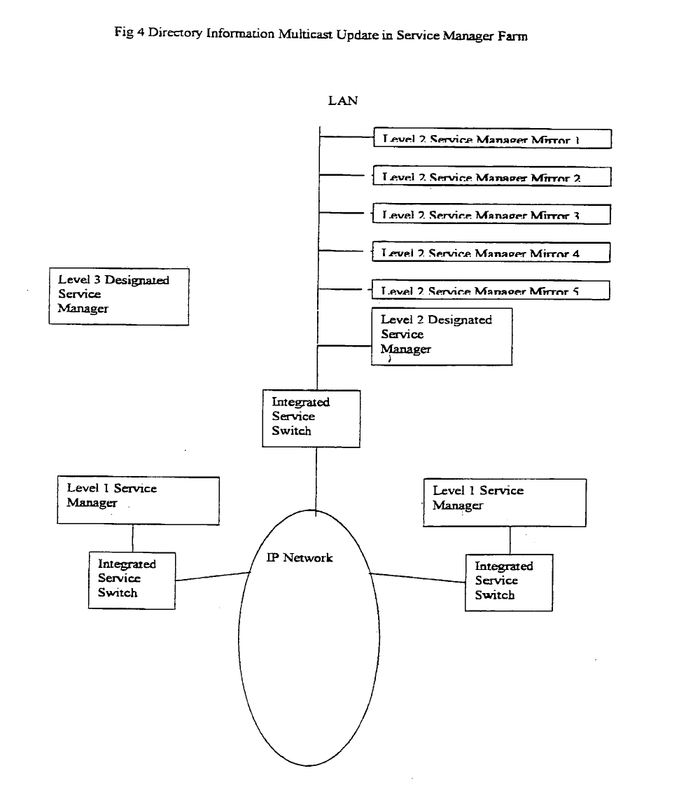

FIG. 4 shows a Directory Information Multicast Update arrangement for a Service Manager Farm and FIG. 5(b) illustrates a Reliable Multicast Transport Protocol Sequence, of a Reliable Multicast Transport Protocol used to simultaneously update information to the service devices in a multicast capable network and to improve performance. It is similar to TCP, but with a two-way send-and-acknowledge handshake instead of a three-way handshake defined between sender and all the recipients to establish the connection. After that, the service manager is responsible for specifying the window size (in packets) such that a sender can send a message without acknowledgement. The window size is one of the service attributes registered by each service engine to the service manager. The service manager choosing the lowest value from the service attribute of the window size registered by each recipient. At the end of each window, the service manager is also responsible for acknowledging the reception on behalf of all other recipients. It is recommended that the service manager should wait a small silent period, which could be a configurable value, before sending the acknowledgement. The recipient should send a re-send request from the starting sequence number (for the window) if it detects any out of sequence packet reception or time out without receiving any packet in a configurable value. The sender can choose to re-send from the specified re-send sequence number or terminate the connection and restart again. Unless the connection is terminated, the recipient will simply drop the packet that has been received. The last packet should acknowledge by all the recipients and not just the service manager to indicate the normal termination of the connection. If the service manager detects that any recipient does not acknowledge the last packet within a time-out, it will request to re-send the last packet to that recipient (a unicast packet). If more than three re-sends have been tried, the device will be declared as dead and will be removed from the service engine list by the service manager. If there is only one packet to be delivered, this protocol will become a reliable data gram protocol. Window size is defined as the outstanding packets without acknowledgement. Acknowledgement and re-send requests are both multicast packets which allow the service manager to monitor.

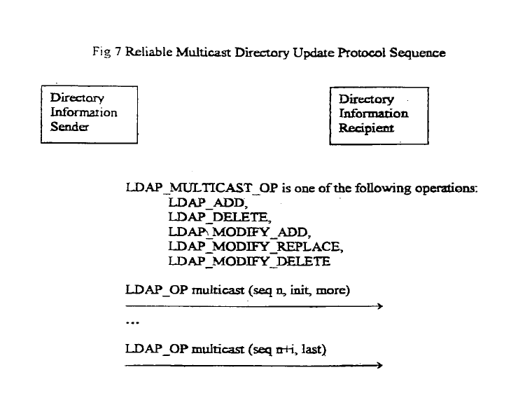

FIG. 7 illustrates a Reliable Multicast Directory Update Protocol running on the Reliable Multicast Transport Protocol described above. The protocol is similar to LDAP over TCP except that the transport layer uses the Reliable Multicast Transport Protocol.

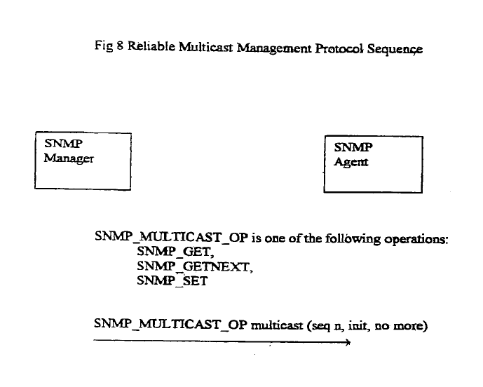

Referring to FIG. 8, a Reliable Multicast Management Protocol Sequence is illustrated The Reliable Multicast Management Protocol Sequence runs on the Reliable Multicast Transport Protocol. Since there is only one packet to be delivered, this protocol will become a reliable multicast data gram protocol. The protocol will be similar to SNMP run over Ethernet except that there is a transport layer to provide the multicast and reliability service.

Hierarchical Management Information and Management Method

The management agent is formed as a part of the service manager. For policy-based service management, management information is defined in different levels. Aggregation of management information is from one level to the next level. For example, the number of web page hits could have a counter for each cache service engine as well as a total counter for the whole level 1 service engine farms or whole data centers.

For configuration management information, the configuration for different levels is also defined. For example, a default router configuration is only for the same subnet, and the DNS server could be for the whole Data Center. The Level 1 service manager is responsible for multicasting the default router configuration to the whole subnet while the Level 2 service manager sends the DNS server configuration to the Level 1 service manager with indication of its Data Center level configuration. Then, the level 1 service manager needs to multicast its members to its subnet. A lower-level configuration or policy cannot conflict with a higher-level policy If it does, the higher-level policy takes precedence over the low-level one.

Directory Schema and SNMP MIB

Several directory information schema and SNMP MIBs need to be defined to support the Hierarchical Scalable Integrated Service Networks (HSISN) of the preferred embodiment:
Web Site object
Web Content object
Service Engine object
Integrated Service Switch object
User objectAnd other objects.

These schema and MIBs may be understood using the following URL as an example:
vision.yahoo.com/web/ie/fv.html (preceded by http://).
   Web Site Object (Origin or Cache Site)
   Origin Web Site

DN (Distinguished Name): http, vision, yahoo, com attributes:
Service Site IP address:
   Cached Service Site

DN (Distinguished Name): subnet1, DataCenter2, CDN3 attributes:
Service Site IP address:
   New Entry Creation of Web Site Object

The origin site will send DGP LDAP_ADD DN: http, vision, yahoo, com to the Level 3 service manager (also as a DNS server) to add a new entry.

Entry Modification of Web Site Object

Based on the service level agreement, the Level 3 service manager will send DGP LDAP_MODIFY_ADD web site object entry's attribute of Service Site Location. These IP addresses will add to the list of DNS entries of vision.yahoo.com.

Yahoo's DNS server, which is responsible for the vision.yahoo.com, refers the DNS request for vision.yahoo.com to a DNS in the level 3 service manager. The DNS in the level 3 service manager will reply with the IP address of a service site that has lowest service metric, to the subscriber or based on other policies.

Cached Web Site Selection Based on the Best Response from the Cached Web Site to the Subscriber

The vision.yahoo URL listed above provides an example of a YAHOO™ web site with a video based financial page. The Internet access provider's DNS server will refer to Yahoo's DNS server, and for vision.yahoo.com. Yahoo's DNS server will refer to the Level 3 service manager of the content distribution service provider.

Each data center may have one or more service web sites, and each service web site may be served by a server farm with a virtual IP address. If there are multiple caching service sites of vision.yahoo.com available (ex. site one is 216.136.131.74, site two 216.136.131.99) all are assigned to serve vision.yahoo.com and the DNS in the level 3 service manager will have multiple entries for vision.yahoo.com. It will select one of the sites as the DNS reply based on policies (weighted round robin or service metric from these sites to the subscriber). For example, IP address 216.136.131.74 may be selected by the DNS as the response to the request for the above-listed vision.yahoo URL.

Service Metric

The Service metric from subscriber 1 to site 1 is the current average server service response time by site 1 plus a weight multiplied by the current proximity from subscriber 1 to site 1. The weight is configured based on policy. The site 1 calculates the current proximity by the formula mentioned above. The site 1 Level 1 service manager will receive the response time from each server in their keep-alive message by the service engine to calculate the current average service response time by servers as a loading factor of this site.

Web Content Object (In Either Origin or Cached Site)

DN: fv.html, ie, web, http, vision, yahoo, com attributes:
Original Content Location: IP address of the origin server
Cached Content Location: DN of the cached service site 1, number of cached service engines that have this content in site 1, DN of the cached service site 2, number of cached service engines that have this content in site 2, DN of the cached service site 31, number of cached service engines that have this content in site 31, DN of the cached service site 41 . . .
Cached Content Service Engine MAC address in the Level 1 service manager:
   Service engine 1 MAC (apply only to Level 1 service manager),
   Service engine 2 MAC (apply only to Level 1 service manager),
   . . .
Number of Caching service engines that have the cached content
Content last modified date and time:
Content expire date and time:
. . .
   Service Engine Object

DN: IP Address, Subnet1, DataCenter2, CDN3 attributes:
Service Type:
Service engine Name:

Service engine Subnet mask:
Service engine MAC addresses:
Service engine Security policy: use SSL if different Data Center
Service Manager IP address:
Service engine certificate:
   Integrated Service Switch Object

DN: IP address on server farm interface, Subnet1, DataCenter2, CDN3 attributes:
Switch Type:
Switch IP address:
Switch MAC address:
Service Manager IP address:
Switch certificate:
   User Object

DN: name, organization, country attributes:
Postal Address:
Email address:
User certificate:
Accounting record:
   New Entry Creation and Modification of Web Content Object

Based on the service agreement, the origin site will send DGP LDAP_ADD DN: fv.html. ie, web, http, vision, yahoo, com to the Level 3 service manager. After 216.136.131.74 is selected by the DNS as response, the subscriber sends http request as 216.136.131.74 (preceded by http://).

The integrated service switch of this virtual IP address will direct the request to one of the less congested caching service engines, such as caching engine one. If the content is not in caching engine one, the integrated service switch sends an LDAP search request to its level 1 service manager. If the level 1 service manager doesn't have the content either, it refers to its level 2 service manager. If the level 2 service manager doesn't have the content either, it refers to its level 3 service manager. The level 3 service manager will return the attributes of origin server IP address, indication of cacheable or not, and other content attributes. In case of a not cacheable attribute, the caching engine one will http-redirect the subscriber to the origin server.

If a cacheable content is indicated, the caching engine one will then initiate a new http session on behalf of the subscriber to the origin server and cache the content if “cacheable” is also specified in the http response from the origin server. The redirect message is also supported by RTSP, but may not always be supported by other existing application protocols. Once the content is cached, then it will LDAP_ADD the object of DN: fv.html, ie, web, http, vision, yahoo, com to the Level 1 service manager. If the object is not found in the Level 1 service manager, then DN: fv.html, ie, web, http, vision, yahoo, com is added to the attribute of the Cached Content Location of itself (i.e., the DN of the service engine). If the object is found in the Level 1 service manager, then the object is modified and added as a new Cached Content Location attribute. The Level 1 service manager will then perform DGP LDAP_ADD or DGP LDAP_MODIFY_ADD DN fv.html, ie, web, http, vision, yahoo, com on the Level 2 service manager. The Level 2 service manager will then perform DGP LDAP_ADD or DGP LDAP_MODIFY_ADD DN: fv.html, ie, web, http, vision, yahoo, com on the Level 3 service manager.

The update of the cache location directory information is a triggered update operation that should be a lot faster than the periodical synchronization process used in the existing replication process among LDAP servers.

Content Retrieval from Nearest Location (Origin or Cached)

Retrieval from a neighbor cache service engine is managed by the same level 1 service manager in the same LAN. If another subscriber sends an http request as 216.136.131.74/web/ie/fv.html, the http request is forwarded by the integrated service switch to service engine 2, which is managed by the same level 1 service manager (together with an LDAP Server) as service engine 1. When service engine 2 does not have the content, LDAP_SEARCH from its level 1 service manager, service engine 2 will return the attribute with service engine 1 as the content cached location.

Since it is cacheable content, service engine 2 will then initiate a new http session on behalf of the subscriber to the service engine 1 instead of the origin server and will cache the content in addition to responding to the content for its subscriber. Once the content is cached, service engine 2 will LDAP_ADD to the same level 1 service manager (also as LDAP Server). The entry should have existed, and therefore the service engine 2 will LDAP_MODIFY_ADD to add another cached location (itself) to the content attribute.

Retrieval from a neighbor site is managed by the same level 2 service manager for the whole Data Center. If another subscriber sends an http request to the second service site as 216.136.131.74/web/ie/fv.html, the http request is forwarded to service engine 31 by the integrated service switch of the service site of 216.136.131.99. If service engine 31 does not have the content, an LDAP_SEARCH is carried out by its Level 1 service manager, and if the Level 1 service manager does not have the content either, the request is referred to the Level 2 service manager, which will return the site of 216.136.131.74 as the cached location with an attribute of the number of service engines that have the content. In case there are two or more sites that have the content, the site that has more service engines that have the content is chosen. Service engine 31 will then initiate a new http session on behalf of the subscriber to 216.136.131.74 instead of the origin server. And the service engine 31 will cache the content in addition to responding the content to its subscriber. Once the content is cached, server engine 31 will LDAP_ADD to its level 1 service manager (also as LDAP Server). If the entry is not found, the level 1 service manager will add DN: fv.html, ie, web, http, vision, yahoo, com with attribute of Cached Content Location of itself (MAC address). Service engine 31's Level 1 service manager will also DGP LDAP_ADD DN: fv.html, ie, web, http, vision, yahoo, com to the Level 2 service manager. If the entry should be found, the level 2 service manager will modify to add another cached location (itself) to the content attribute and increment the number of sites that have the content.

Retrieval from neighbor Data Center that is managed by the same Level 3 service manager for the whole CDN (Content Delivery Network). If there is the second service site of 216.136.131.74 is located at another Data Center and if that Data Center does not have such cached content yet, the LDAP_SEARCH will eventually refer to the Level 3 service manager to find the cached Data Center location. The http proxy will then be initiated on behalf of the subscriber from the caching service engine of one Data Center to its neighbor Data Center instead of the origin server, if the neighbor Data Center has the cached content. In case multiple Data Centers have the cached content, the number of caching service engines in that Data Center that have the cached content determines the preference.

A engine is able to dynamically discover its referral LDAP server, which is its level 1 service manager. The level 1 service manager may or may not need a static configuration to find its Level 2 service manager, depending on whether or not the link state routing protocol (ex. OSPF) is running. If it is running, the opaque link state packet can be used to carry the service manager information and be flooded to the routing domain. The LDAP search result could also be influenced by policy configuration. It is also possible to add policy management related attributes of that content, such as proxy or redirect, cache life-time if cacheable, etc.

Cached Content Invalidation

When the origin server modifies the content of DN: fv.html, ie, web, http, vision, yahoo, com, it will perform an LDAP_MODIFY_DELETE to remove all the Cached Content Locations from the Level 3 service manager. Alternatively, it can conduct a scheduled content update by specifying or changing the expiration date attribute of the content through DGP. The Level 3 service manager will LDAP_MODIFY_DELETE to remove all the Cached Content Locations or change the expiration date from Level 2 service managers that it manages.

The Level 2 service manager will then LDAP_MODIFY_DELETE to remove all the Cached Content Locations or change the expiration date of the Level 1 service managers that it manages after which the Level 1 service manager will notify (multicast) all its caching service engines to remove that Cached Content from its storage.

When the content has been scheduled to be changed by the origin server, the origin server can also send LDAP_MODIFY_REPLACE to modify the content last modified date and time attribute in the level 3 service manager and propagate downward to lower level service managers and caching service engines. Based on the last modified date and time, the server determines when to throw away the old content.

The Dynamic Discovery of Among Service Engines (LDAP Client), Level 1 Service Manager and Level 2 Service Manager

In a layer 2 LAN environment, a layer 2 multicast can be utilized to propagate the service information to the level 1 service manager from all the service engines. A well-known Ethernet multicast address will be defined for Level 1 service managers including a primary and back up Level 1 service manager.

At the link state routing domain, opaque-link-state-packet flooding will be used to propagate the service engine and services it provides in one area or one autonomous system by all the Level 1 service managers and Level 2 service managers.

Level 2 service managers should always flood to the whole autonomous system. If the whole autonomous system only has one Level 2 service manager, then opaque link state packets from the Level 1 service manager should flood to the whole autonomous system. If each area has one Level 2 service manager, then opaque link state packets from the Level 1 service manager should flood to the area only. The Level 2 service manager can refer to other Level 2 service managers first before referring to the Level 3 service manager for directory information, although the DGP connection to other same level service manager is not allowed.

Beyond one autonomous system, an IP multicast may be utilized to propagate the service within the IP multicast tree among Level 2, Level 3 or Level 4 service managers. The static configuration can also be used to propagate, search and update the service among service managers.

Content Delivery with Quality (Possible Other Policy Too) Through Hop by Hop Flow Advertisement from Caching Service Engine to Client with Crank Back

A hop by hop flow advertisement protocol for IP flow is specified based on pattern-matching rules. Flow advertisement will start from the caching service engine to its upstream integrated service switch after the authentication and accounting are checked or initiated, and then proceed from the integrated service switch on a hop by hop basis to the end user, if the flow advertisement protocol is supported. The end user is not required to be involved in the flow advertisement protocol. In case the flow advertisement protocol is not supported, each hop will map the flow and flow attribute to its (could be different) upstream traffic characteristics through static configuration or a signaling protocol. For example, the IP flow can map to ATM SVC or PVC, and the ATM PVC or SVC can also map to IP flow through this hop-by-hop flow advertisement. If IP MPLS is also available, the IP flow advertisement can map to MPLS through an MPLS signaling protocol. If the upstream hop does not support any flow signaling, the flow advertisement would be stopped.

Flow switching requires every hop to include all network devices from layer 2 to layer 7 switching devices as long as the flow can be mapped and defined. If only the class of traffic is defined, the down stream hop should still try to map to the appropriate traffic class on the upstream. The typical example of quality of service can map to whatever available on the up stream network such as DiffServ, Cable Modem's SID and 802.1p.

In case a link or switch is down along the flow path, the upstream hop should terminate the flow by sending a flow withdraw advertisement to its further upstream neighbor and propagate to the end user. On the other hand, the downstream hop should initiate another flow advertisement to the other available upstream hop and further propagate to the end user to re-establish the flow. If no upstream hop can accept the flow, the switch should terminate the flow, and advertise flow termination (crank back) to its downstream hop and its downstream hop should find another available upstream hop so as to try to propagate to the end user again. If the upstream hop is not available again, advertise flow termination (crank back) to its downstream hop should continue until one available switch is found, or back to the service engine which will abort the flow.

VPN with PKI

Finally, a VPN with PKI can use the same directory enabled network, for a non-content related service engine like an IPSEC engine. The VPN with PKI can also refer to its Level 1 service manager to search for the certificate and the like an refer to Level 2 and 3 service managers for hierarchical user and accounting management.

1. A network system for management of hierarchical service and content distribution via a directory enabled network, comprising:
at least one level 4 service manager responsible for management of multiple content delivery networks;
at least one level 3 service manager responsible for management of one of the content delivery networks having multiple data centers;
at least one level 2 service manager responsible for management of one of the data centers having multiple server farms or service engine farms; and
at least one level 1 service manager for establishing a directory information routing protocol with the at least one level 2 service manager.

2. The network system of claim 1, wherein each server of the server farm is connected by LAN Ethernet Switch Network that supports layer 2 multicast operations.

3. The network system of claim 1, wherein each server of the server farm is connected by an Infiniband switch.

4. The network system of claim 1, wherein data passing through the data center passes through an IPSEC tunnel to guarantee privacy and security, so as to form a VPN among the data centers.

5. The network system of claim 1, wherein the at least one level 1 service manager is managed to establish a dissimilar gateway protocol connection with at least one of the at least one level 2 service managers, the at least one level 2 service manager is managed to establish a dissimilar gateway protocol connection with at least one of the at Least one level 3 service managers, the at least one level 3 service manager is managed to run as a DNS server, which directs a user's request to a different data center for geographical load balancing, and the service manager of the origin at server farm is also managed to establish a dissimilar gateway protocol connection with the parent service manager thereof.

6. A network system for management of hierarchical service and content distribution via a directory enabled network comprising:
at least one level 4 service manager responsible for multiple content delivery network management and storing the content location information of at least one content delivery network;
at least one level 4 service manager responsible for management of multiple content delivery networks and storing content location information of the at least one content delivery network;
at least one level 3 service manager responsible for management of one of the content delivery networks having multiple data centers, wherein each of the at least one level 3 service managers stores the content location information of the corresponding content delivery network, and the content information of data centers;
at least one level 2 service manager responsible for management of one of the data centers having multiple server farms or service engine farms, wherein each of the at least one level 2 service managers of said one of the data centers stores only the content location information of the corresponding data center; and
at least one level 1 service manager for establishing a directory information routing protocol with the at least one level 2 service manager, so as to manage each of the server farms, wherein the at least one level 1 service manager and the at least one level 2 service manager are created through a LAN multicast and a link state routing protocol's opaque link state packet flooding with service information.

7. The network system of claim 6, wherein each server of the server farm is connected by a LAN Ethernet Switch Network that supports Layer 2 multicast operations.

8. The network of claim 6, wherein each server of the server farm is connected by an Infiniband switch.

9. The network of claim 6, wherein data passing through the data center passes through an IPSEC tunnel to guarantee privacy and security, so as to form a VPN among the data centers.

10. The network of claim 6, wherein the at least one level 1 service manager is managed to establish a dissimilar gateway protocol connection with at least one of the at least one level 2 service managers, the at least one level 2 service manager is managed to establish a dissimilar gateway protocol connection with at least one of the at least one level 3 service managers, the at least one level 3 service manager is managed to run as a DNS server, which directs a user's request to a different data center for geographical load balancing, and the service manager of the origin at server farm is also managed to establish a dissimilar gateway protocol connection with the parent service manager thereof.

11. A method for management hierarchical service and content distribution via a directory enabled network including at least one level 4 service manager, at least one level 3 service manager, at least one level 2 service manager, and at least one level 1 service manager comprising the steps of:
managing at least one content delivery network having multiple data centers and storing the content location information of the at least one content delivery network;
managing the data centers having multiple server farms or service engine farms; and
establishing a directory information routing protocol between the at least one level 1 service manager and the at least one level 2 service manager, and managing each of the server farms.

12. The method of claim 11, further comprising a step of establishing a dissimilar gateway protocol connection between the at least one level 2 service manager and at least one of the at least one level 3 service managers.
